(19) United States
(12) Patent Application Publication
(10) Pub. No.: US 2019/0133157 A1
(43) Pub. Date: May 9, 2019

(54) METHOD FOR COOKING A FOOD PRODUCT IN A VACUUM OVEN AND A VACUUM OVEN

(71) Applicant: MicVac AB, Mölndal (SE)

(72) Inventor: Martin Gustavsson, Escaldes-Engordany (AD)

(73) Assignee: MicVac AB, Mölndal (SE)

(21) Appl. No.: 16/097,642

(22) PCT Filed: May 4, 2017
(86) PCT No.: PCT/EP2017/060705

§ 371 Date: Oct. 30, 2018

(30) Foreign Application Priority Data
May 4, 2016 (SE) 1650606-5

(51) Int. Cl. A23L 5/10; F24C 15/34; F24C 7/08

(52) U.S. Cl. CPC A23L 5/17; F24C 7/085; F24C 15/34

(57) ABSTRACT

An oven operable for cooking at both atmospheric and sub-atmospheric pressure, and a method of cooking are disclosed. The oven comprises a housing, defining a chassis comprising a cavity capable of receiving a food package. Moreover, the oven comprises at least one heating element, a gas outlet connectable to a vacuum source. The oven further has a maximum weight capacity for the food product and wherein the chassis is arranged to have a total heat capacity in the range of 1.5-3.0 times that of a heat capacity of water having the same weight as the maximum weight capacity of the oven. Hereby a simple and cost-efficient oven is presented, that is capable of heating a food product while the food product is kept in a sub-atmospheric pressure inside the oven.

### TECHNICAL FIELD OF THE INVENTION

The present invention relates to preservation of foodstuffs by dehydration, more specifically it relates to a vacuum oven.

### BACKGROUND

Dehydration or drying, in food processing, is one of the oldest known methods of preserving food. It has been discovered that even ancient societies practiced the drying of meat and fish in the sun long before recorded history. Dehydration of food is still today a commonly used preservation method since it efficiently prevents the growth of micro-organisms and decay as it simultaneously reduces the weight of the final product. Moreover, by using dehydration as a means to preserve food, the need for additional treatments and chemical additives is diminished.

However, it is known that dehydration or evaporation of water during the preparation or cooking of food is an important aspect to consider, in particular when cooking meat, fish or poultry. To achieve great results while cooking e.g. meat or fish, there are a lot of parameters to consider, such as, e.g. moisture content, temperature, temperature differences (both between the oven and food content and between different regions of the food content), etc.

For example, cooking or preparation of fish is often known to be a delicate procedure since relatively small deviations in temperature and moisture content have significant impact on the end result in terms of taste and texture. If one is to cook fish in a conventional oven applying only dry heat, one often runs the risk of overcooking the fish, in particular the meat closest to the surface/skin which easily reaches a too high temperature and consequently is perceived as dry. This is often relieved by cooking at very low temperatures, albeit, it takes enormous amounts of time, which is generally a scanty resource in many kitchens.

As a remedy to this, some ovens include a steam generator in order to produce steam so that a more “humid heat” is applied, however, the resulting texture of the meat is often perceived as “soggy”, since not enough water has been able to evaporate.

There is therefore a need for an oven that is capable of dehydrating at low enough temperatures so that the food is kept from overcooking, thereby concentrating flavors while achieving an adequate dehydration of the food product, all in a time efficient manner.

### SUMMARY OF THE INVENTION

It is accordingly an object of the present invention to provide a cooking method and an oven which alleviates all or at least some of the above mentioned drawbacks of the presently known technology.

This object is achieved by means of a method and oven as defined in the appended claims. The term exemplary is in the presented context to be interpreted as serving as an example, instance or illustration.

According to an aspect of the present invention there is provided method of cooking a food product in an oven operable for cooking at both atmospheric and sub-atmospheric pressure, the oven comprising a cavity containing a food product, the method comprising:

(i) at atmospheric pressure, heating said food product inside said cavity, until a predefined core temperature is reached at a core region of said food product or until a predefined maximum surface temperature threshold is reached at a surface region of said food product;

(ii) decreasing the pressure inside said cavity to a sub-atmospheric pressure level and maintaining said sub-atmospheric pressure level for a predefined period of time or until a surface temperature of said food product reaches a predefined flash cooling temperature threshold;

(iii) increasing the pressure inside said cavity to atmospheric pressure and, if said core temperature threshold has not been reached, re-heating, re-heating said food product inside said cavity until the predefined core temperature threshold is reached in said core region or until said predefined maximum surface temperature threshold is reached at the surface region of said food product again.

Hereby a method for simple, precise and time efficient cooking of a food product is presented.

The term surface temperature does not necessarily mean the actual surface temperature but the temperature of a region of the food product close to the surface, e.g. 0-3 cm from the surface of the food product towards the core. The steps of decreasing the pressure and increasing the pressure together with the re-heating of the product may be performed at least two times in some exemplary embodiments, in order to cycle between high and low pressures. Moreover, the sub-atmospheric pressure may be different for different cycles, e.g. the first decrease may be to a first sub-atmospheric pressure level, and any subsequent decrease in the following cycles may be at a different, preferably lower sub-atmospheric pressure level.

The term flash cooling temperature threshold is to be understood as a temperature of the surface region of the food product that is below the predefined maximum surface temperature threshold. Thus instead of keeping the oven in the sub-atmospheric mode for a set period of time, one may keep it in the sub-atmospheric mode until a desired “flash-cooling” effect of the surface region has been achieved.

The present invention is based on the realization that ovens operable for cooking at both atmospheric pressure and sub-atmospheric pressure can be utilized for achieving precise and thereby high quality cooking by relatively simple means. In more detail, it was realized by the present inventor that presently known methods rely a great deal on the chefs experience and expertise in terms of how the heat spreads through the food product (temperature equalization) and how much effect various oven temperatures have on the end result, and so on. Thus, by introducing a flash-cooling step (decreasing of pressure inside the cavity), the oftentimes problematic peripheral/surface regions of the food product can be kept from overcooking. Further, the overall time consumption can be decreased since the oven can be operated at a higher temperature without running the risk of overcooking certain delicate areas of the food product. Moreover, the inventive method allows for high quality dehydration of food products by cycling between different pressure and temperature settings. For example, the decreasing of the pressure and increasing of the pressure and re-heating may be performed at least two times.

Moreover, the inventive method allows for flash cooling of the food product after it is cooked in order to precisely control the core temperature of the food product by ensuring that the surrounding regions having a higher temperature do not increase the core temperature. By setting the pressure in the oven during the sub-atmospheric mode to a predefined value, which corresponds to a specific boiling point, the otherwise unwanted further increase of the core temperature due to temperature equalization is effectively halted. For example, the food product may be a large piece of meat, and a desired core temperature may be 72° C. and after the desired core temperature is detected, then, by setting the oven in the sub-atmospheric mode, whereby the pressure in the cavity is lowered to approximately 345 mbar, the boiling point is brought down to roughly 72° C. which results in that the portions of the meat closer to the surface (generally having a higher temperature) are flash cooled which ensures that the core temperature doesn't increase any further than 72° C. Conventionally one had to estimate how much the temperature would rise in the core after cooking due to temperature equalization. Thus the present invention greatly simplifies the cooking of e.g. meat, fish, poultry, etc. by providing a very simple and efficient means of precisely controlling the temperature of the food product without any need for estimations or guessing of a final core temperature. As an alternative, the trigger to set the oven in the sub-atmospheric mode may be based on a temperature threshold of another one of the regions of the products, which may e.g. be a surface/peripheral region of the food product.

Thus, in an exemplary embodiment the method includes a final step of flash cooling the food product once the predefined core temperature threshold is reached, in order to ensure that the final core temperature is maintained in the food product. This final step efficiently diminishes the risk of the core temperature of the food product increasing while “resting”, and enables operators or chefs to control the internal temperatures of the food product with extreme precision.

Preferably, the method comprises a step of turning off any heating element in the oven while the oven is operating at the sub-atmospheric pressure level. This is in order to avoid destroying the heating elements due to poor convection in the sub-atmospheric mode.

In accordance with another embodiment of the invention, the method may further comprise:

(iv) repeating steps (ii) and (iii), until the predefined core temperature threshold is reached in the core region of said food product; or

(iv) repeating steps (ii) and (iii), until a predefined moisture content of said food product is reached. The latter being an advantageous step in processes for dehydrating foodstuffs, such as, e.g. when making beef jerky.

Furthermore, the method may have a core temperature focus, and therefore, in accordance with an embodiment of the present invention, the method may comprise:

at atmospheric pressure, heating the food product inside the cavity, until a first predefined core temperature threshold is reached at a core region of the food product;

decreasing the pressure inside the cavity to a sub-atmospheric pressure level and maintaining the sub-atmospheric pressure level for a first period of time or until a surface temperature of the food product reaches a predefined temperature value;

increasing the pressure inside the cavity to atmospheric pressure and re-heating the food product inside the cavity until a second predefined core temperature threshold is reached at the core region;

wherein the step of decreasing the pressure comprises turning off any heating element in the oven.

The decreasing of the pressure and increasing of the pressure and re-heating may be performed a plurality of times.

In another exemplary embodiment, the step of heating is performed at a first oven temperature defining a first delta-T, and wherein each subsequent re-heating is performed at a second oven temperature defining a subsequent delta-T being smaller than any preceding delta-T.

The term delta-T in the present context is the temperature difference between the core temperature value and the oven temperature value.

For example, in a first heating step of a cooking sequence, the predefined core temperature threshold may be set to 50° C. and the oven temperature to follow a delta-T of 40° C., meaning that the oven temperature is controlled to be always 40° C. above a current core temperature. Once the core temperature is reached, the oven (now being approx. 90° C.) is set in a sub-atmospheric mode and the boiling point may be decreased to a desired level in order to reduce the temperature of the more peripheral portions of a food product by flash cooling (e.g. reducing the pressure to 230 mbar the boiling point is reduced to approx. 60° C. whereby the temperature of the peripheral portions of the food product will be lowered towards 60° C.). In a subsequent heating/re-heating step the predefined core temperature threshold may be set to 60° C. and the delta-T should now be smaller so the oven temperature is set to be e.g. 30° C. above the core temperature, which will result in a more even temperature distribution throughout the food product. Using this so called delta-T cooking method is known per se, however, the present inventors realized that by introducing intermediate flash cooling steps where the oven is set in a sub-atmospheric mode, the temperature distribution can be kept even more uniform than previously possible. Moreover, the latent heat stored in the chassis efficiently saves energy since the oven is kept warm. Also, by measuring temperatures at different regions of the food product, e.g. by using more than one temperature probe the operator is given more parameters (e.g. surface temperature) which can aid in controlling the operation of the oven and improve results.

Further, by utilizing a second temperature probe arranged in a peripheral portion one improve control of the time period the oven should be kept in the sub-atmospheric mode. Thus, the method may have a “surface temperature focus” and therefore, in accordance with another embodiment of the invention there is provided a method of cooking a food product in an oven operable for cooking at both atmospheric and sub-atmospheric pressure, the oven comprising a cavity containing a food product, the method comprising:

(i) at atmospheric pressure, heating the food product inside the cavity, until a predefined maximum surface temperature threshold is reached at a surface region of the food product;

(ii) decreasing the pressure inside the cavity to a sub-atmospheric pressure level and maintaining the sub-atmospheric pressure level for a first period of time or until a surface region of the food product reaches a second predefined temperature value (i.e. a predefined flash cooling temperature threshold);

(iii) increasing the pressure inside the cavity to atmospheric pressure and re-heating the food product inside the cavity until one of a predefined core temperature threshold is reached in the core region of the product or until the maximum surface temperature threshold is reached again;

(iv) repeat steps (ii) and (iii), until the predefined core temperature threshold is reached in the core region of the food product.

The above described embodiments of the inventive method may advantageously be performed in an oven as will be discussed in the following. Thus, according to another aspect of the present invention there is provided an oven operable for cooking at both atmospheric and sub-atmospheric pressure, the oven comprising:
a housing defining a chassis comprising a cavity capable of receiving a food package including a food product;
at least one heating element;
a gas outlet connectable to a vacuum source for withdrawing gas from the cavity in order to set the oven in a sub-atmospheric mode;
a controller configured to control said oven and to cycle different pressure and temperature profiles based on a predefined user-setting;
a temperature probe connected to said controller and arranged to measure a temperature of said food product; and
wherein said controller is further configured to:
receive and store a temperature threshold for the temperature probe;
control said heating element in order to heat said food product arranged in said cavity at said oven temperature;
set said oven in the sub-atmospheric mode when said temperature probe detects the temperature threshold.

Hereby, a new and improved oven is presented, which is capable of achieving dehydration of a food product at a much faster pace than previously possible, while at the same time providing means for improving the overall quality of the cooked food product in terms of taste and texture by utilizing the temperature probe(s) for precise control of the cooking process.

With this aspect of the invention, similar advantages and preferred features are present as in the previously discussed aspect of the invention, and vice versa.

In accordance with an embodiment of the invention, the temperature probe is a core temperature probe arranged to measure a core temperature of said food product and the temperature threshold is a first temperature threshold, and wherein the controller is further configured to:

receive and store a second temperature threshold for said core temperature probe, said second temperature threshold being higher than said first temperature threshold;

control said heating element in order to heat said food product arranged in said cavity at a predefined oven temperature;

set said oven in the sub-atmospheric mode by controlling said vacuum source, when said first temperature threshold is detected by said core temperature probe in order to cool the food product;

increase the pressure in said cavity by introducing air to the cavity and turning on said heating element in order to heat the food product again until said second goal temperature threshold is detected by said core temperature probe. The oven may be kept in the sub-atmospheric mode for a predefined duration of time.

This configuration allows for very precise control of the temperature throughout the whole food product while it is being cooked in the oven. By cycling different ambient pressure levels (and temperatures) the otherwise more rapidly increasing surface temperature, as compared to the core temperature, can be regulated and controlled so that a far more even cooking of the food product is achievable, since all regions or portions of the food product is kept at substantially the same temperature through the whole cooking process. For example, once the first core temperature threshold is reached, the temperature of the portions closer to the surface of the food product is generally higher than the core temperature. Thus, by reducing the pressure inside the cavity and bringing down the boiling point the surface temperature may be brought down to be closer to the core temperature while the core temperature remains substantially the same, and subsequently increasing the pressure again in order to continue with a second cooking cycle, the whole food product is much more evenly cooked and the risk of dry and or burnt portions is effectively reduced.

Moreover, in accordance with yet another exemplary embodiment, the the oven has a core temperature probe arranged to measure a core temperature of said food product and where the oven further has a surface temperature probe connected to the controller, said surface temperature probe being arranged to measure a temperature of a surface region of the food product; and

wherein the controller is further configured to:
(i) receive and store a predefined maximum surface temperature threshold and a predefined flash-cooling temperature threshold for the surface temperature probe,
(ii) at atmospheric pressure, control the heating element in order to heat the food product inside said cavity, until the temperature threshold is detected by the core temperature probe or until the predefined maximum surface temperature threshold is detected by the surface temperature probe;
(iii) set the oven in the sub-atmospheric mode for a predefined duration of time or until the predefined flash cooling temperature threshold is detected the surface temperature probe, by controlling the vacuum source;
(i) repeat steps (ii) and (iii), until the predefined core temperature threshold is reached in a core region of the food product.

Moreover, the controller may further be configured to turn off any heating element during the time the oven is in the sub-atmospheric mode.

By configuring the controller as described above, where two temperature probes are utilized, highly autonomous and precise cooking of delicate food products is enabled. The controller may further be configured to receive and store a predefined oven temperature, and to control the heating element in order to heat the food product arranged in the cavity at the predefined oven temperature.

In more detail, by providing the at least two temperature probes in order to simultaneously measure a temperature of at least two different regions of said food product. Furthermore, since the temperature probes are preferably connected to the controller, the measurement data may be used to control the operation of the oven, for example, by setting temperature thresholds which trigger the controller to perform a specific task, e.g. increase oven temperature, turn off the fan, increase humidity, decrease pressure, etc. By having multiple temperature probes the oven can be used for extremely precise cooking, for example, if the oven has two probes, one may be arranged such that it measure the core temperature of e.g. a large steak and the other one may be arranged such that it measures the temperature of a region/portion of the steak located closer to the surface, e.g. 0.1-3 cm from the outer surface (i.e. surface region). Hereby one can ensure that the food product, large steak in this case, is cooked more evenly such that the temperature of the outer regions is not too high as compared to the core temperature. Moreover, it is advantageous to use the sub-atmospheric mode of the oven in order to further control the overall temperature of the food product.

Further, the controller may, in an embodiment be configured to:

receive and store a predefined maximum temperature threshold for at least one of the temperature probes and a predefined oven temperature;

control the heating element in order to heat the food product arranged in the cavity at the oven temperature;

set the oven in the sub-atmospheric mode for a predefined duration of time by controlling the vacuum source, when the at least one of the temperature probes reaches the maximum temperature threshold;

turn off the heating element during the time the oven is in the sub-atmospheric mode.

Even further, in accordance with yet another embodiment of the present invention, the oven has a maximum weight capacity for the food product and wherein the chassis is arranged to have a total heat capacity in the range of 1.5-3.0 times that of a heat capacity of water having the same weight as the maximum weight capacity of the oven. Hereby, a simple and cost-efficient oven is presented, that is capable of heating a food product while the food product is kept in a sub-atmospheric pressure inside the oven.

The present inventor also realized that even with the many advantageous provided by “vacuum ovens” (i.e. cooking at a sub-atmospheric pressure) there is an immense problem regarding heat transfer. In particular at very low pressure levels, where it is not possible to use conventional heating elements (may also be known as baking elements or broiling elements) since the lack of air inside the cavity would burn the heating elements and potentially cause irreparable damage to the oven. This is mainly due to the fact that the heat cannot be transferred or led away from the heating elements. Thus, the convection is extremely bad; moreover, any fan used to aid convection during the cooking process must also be shut and sealed during operation in sub-atmospheric pressure, further impinging the convection in the oven.

Thus, by arranging the chassis of the oven (e.g. chassis of the cavity on the inside of the isolative layer of conventional ovens) to be capable of storing a large amount of latent heat within itself, heat can be transferred to the food product by means of radiation instead. This allows for addition of heat to a food product while it is being subdued to sub-atmospheric pressure which effectively speeds up dehydration. Moreover, dehydration at low temperatures is made achievable with an oven in accordance with the present invention, this is desirable since it concentrates flavors that otherwise would run off (due to excess water running off the cooked food product), or be destroyed by heating too long at too high temperatures to achieve the same weight loss of the product. Thus the oven effectively enhances flavors of the food product(s) without any unnatural additives, allowing for safer and healthier cooking.

An illustrative example would be the baking of bread, where a temperature of 100° C. is generally enough to achieve the desired effect on the starch granules, however, a problem with conventional ovens is that this is achieved after approximately half the cooking/baking time in the oven, and for the remainder of the time the outer portions of the bread are simply drying out. However, by being able to reduce the pressure in the cavity during baking and simultaneously apply heat to the bread (due to latent heat stored in the new and improved chassis), one can bake with a lower boiling point and conserve heat sensitive aromas and also reduce the formation of acrylamide and other unhealthy substances which form at high temperatures, resulting in a tastier and healthier end product.

The chassis has a total heat capacity in the range of 1.5-3.0 times that of a heat capacity of water having the same weight as the maximum weight capacity of the oven. Preferably the total heat capacity of the chassis is in the range of 1.5-2.5 times that of a heat capacity of water having the same weight as the maximum weight capacity of the oven, and more preferably the total heat capacity is in the range of 1.8-2.2 times that of a heat capacity of water having the same weight as the maximum weight capacity of the oven.

For example, an oven having a capacity of roughly 15-24 kg of food, and with a chassis comprising stainless steel, the chassis should have a weight of at least 400 kg (i.e. two times the heat capacity of 24 kg of water). This is assuming a heat capacity of stainless steel being about 0.5 kJ/kgK [kiloJoule/kilogram Kelvin] and the heat capacity of water being roughly 4.18 kJ/kgK. The chassis of the oven may however be made of any suitable material and the required mass may be calculated in accordance with the principle described above.

The oven may furthermore comprise a steam-generating arrangement in one exemplary embodiment, in order to be able to provide steam into the cavity. Thereby the oven may operate in a dry heat mode and a moist heat mode. The steam generating arrangement may comprise a water inlet connectable to a water source and/or a boiler. According to another exemplary embodiment, the steam generating arrangement may utilize the at least one heating element to generate the steam for the cavity. The oven may furthermore comprise a fan arrangement in order to improve the convection within the cavity of the oven by ensuring that turbulence is kept in the cavity.

The dimensions of the oven are preferably about the same as the dimensions of the steam ovens in today's restaurant and food-service environments. Such steam ovens has several levels and each level is adapted to receive one food package having a width of about 600 mm and a depth of about 400 mm (i.e. a so called 1/1 gastro package for baking), two food packages having a width of about 300 mm and a depth of about 400 mm (i.e. so called 1/2 gastro packages for baking), four food packages having a width of about 300 mm and a depth of about 200 mm (i.e. so called 1/4 gastro packages for baking) or eight food packages having a width of about 150 mm and a depth of about 200 mm (i.e. so called 1/8 gastro packages for baking). In cooking and preparation of food, the packages usually are somewhat smaller. Hence, the oven may be adapted to receive a package having a width of about 530 mm and a depth of about 325 mm (i.e. a so called 1/1 gastro package), two food packages having a width of about 265 mm and a depth of about 325 mm (i.e. so called 1/2 gastro packages), four food packages having a width of about 265 mm and a depth of about 160 mm (i.e. so called 1/4 gastro packages) or eight food packages having a width of about 130 mm and a depth of about 160 mm (i.e. so called 1/8 gastro packages).

According to one exemplary embodiment, the cavity is capable of receiving at least one food package having a width of 530 or 600 mm. Accordingly, the cavity of the oven of the present disclosure may be capable of receiving at least one food package having a width of 530 or 600 mm. Hence, according to one exemplary embodiment, the cavity may have a width of 530-750 mm. Further, the cavity of the oven of the present disclosure may be capable of receiving at least one food package having a depth of 325 mm. Therefore, according to one exemplary embodiment, the cavity may have a depth of 325-550 mm.

According to another exemplary embodiment, the height of the cavity may be at least 200 mm, more preferably at least 500 mm, even more preferably at least 1300, and most preferably 1800 mm. This means that the oven of the present disclosure may have several levels such that several 1/1 gastro packages can be placed one above each other in the oven.

According to yet another exemplary embodiment, the housing comprises an opening and a door and wherein the housing is sealed when the door is closed. The housing of the inventive oven preferably comprises an opening and a door capable of closing the opening. In a closed configuration, such a door preferably constitutes at least part of a side wall of the housing. Further, the housing is preferably sealed in the closed configuration such that a sub-atmospheric pressure may be maintained inside the cavity.

According to yet another exemplary embodiment, the vacuum source is a vacuum tank connected to the gas outlet. Such a vacuum tank may be an integral part of the oven or a separate tank. Alternatively, the vacuum source can be a vacuum pump connected to the gas outlet. However, a combination is also feasible, where the oven comprises a vacuum pump connected to the vacuum tank. Thus, the vacuum source may for example be a vacuum pump, a vacuum tank or a vacuum tank connected to a vacuum pump. If a vacuum tank is used, the pressure in the cavity may be reduced more quickly than if the gas outlet is connected directly to the vacuum pump.

According to yet another exemplary embodiment, the oven of the present invention may be provided with seals such that a pressure of at least 200 mbar below atmospheric pressure may be maintained in the cavity. Operation of pressurized equipment requires by law to be safe for the operators. An arrangement with sub-ambient pressure is beneficial since it upon failure implodes in contrast to over pressurized equipment that might “explode” and cause injuries to the operator. However, specific legislation exists for devices operating at pressure lower than 500 mbar below atmospheric pressure. 500 mbar below atmospheric pressure may be enough, but the oven may also be adapted for even lower pressures, such as 800 mbar below atmospheric pressure or even 950 mbar below atmospheric pressure. But 500 mbar sub atmosphere makes homologation work towards protection of operator much easier.

Moreover, in yet another exemplary embodiment, the oven comprises an air inlet comprising a valve, by means of which air can be let into the cavity to increase the pressure to atmospheric pressure. This effectively facilitates switching from a sub-atmospheric mode and a regular mode.

As mentioned, the oven comprises a controller configured to control the oven. By controlling the oven, it is meant that the controller is capable of controlling e.g. oven temperature by means of the heating element(s), pressure level inside the cavity by means of the vacuum source and/or the (control) valve of the air inlet/outlet, humidity by means of the steam-generating arrangement, etc. Furthermore, the controller is preferably configured to receive, store and execute user programmable instruction regarding the operation of the oven, the user programmable instructions being provided via a user interface such as e.g. a touch screen, keyboard, or via a wired/wireless connection from some other computing device. Moreover, in yet another exemplary embodiment, the controller is configured to cycle different pressure and temperature profiles based on a predefined user-setting. However, the controller is preferably configured to turn off the at least one heating element and/or the steam generating element when the oven is in a sub-atmospheric mode.

In accordance with yet another exemplary embodiment, the controller is connected to a data communication router and wherein the controller is further configured to send and receive data packets to and from a remote server via the data communication router in order to enable remote support to an operator of the oven.

These and other features of the present invention will in the following be further clarified with reference to the embodiments described hereinafter.

### BRIEF DESCRIPTION OF THE DRAWINGS

For exemplifying purposes, the invention will be described in closer detail in the following with reference to exemplary embodiments thereof illustrated in the attached drawings, wherein:

FIG. 1 shows a schematic illustration of an oven in accordance with an embodiment of the present invention;

FIG. 2 shows a schematic illustration of an oven in accordance with another embodiment of the present invention;

FIG. 3 shows a schematic flow chart representation of a method of cooking food in an oven in accordance with an embodiment of the present invention.

### DETAILED DESCRIPTION

In the following detailed description, preferred embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

Further, the present invention is mainly described with reference to a food container having a plastic lower portion covered with a plastic film on which a valve is arranged. It is however to be understood that any package able to contain food may be used, such as a plastic bag. The materials of the food package are also exchangeable as long as the characteristics and behavior is maintained as described.

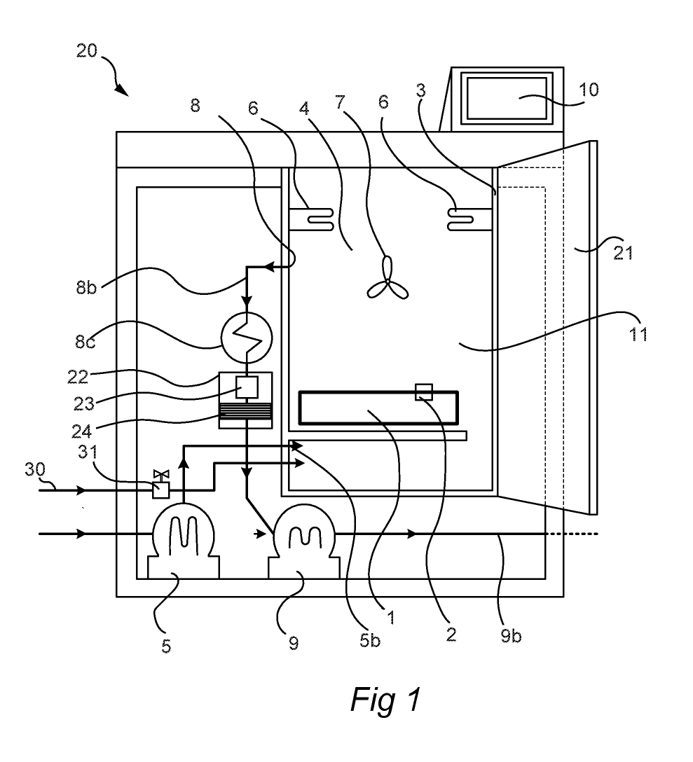

FIG. 1 shows a non-limiting embodiment of a vacuum oven 20. The vacuum oven 20 is suitable for cooking of food products e.g. arranged in a food package 1. Here the food package is illustrated as a sealed package 1 comprising a one-way valve 2 that opens at a pressure, which is normally a pressure of 20-200 mbar (i.e. 20-200 hPa). For example, the package may be a plastic package sealed with a plastic film. The food in the sealed package may for example comprise fish or meat. However, the oven can obviously be used to cook a food product, such as fish or meat placed on a conventional oven tray.

The vacuum oven 20 comprises a housing 3 that defines a chassis 3 comprising a cavity 4 capable of receiving the food package 1. The housing 3 is openable, such that objects. e.g. the food package 1, can be placed in the cavity 4 and taken out of it. The housing 3 is designed to maintain, in a closed configuration, a sub-atmospheric pressure, which is often somewhat inaccurately referred to as “vacuum”, in the cavity 4. The housing 3 is thus provided with seals to prevent substantial amounts of air from leaking in when the sub-atmospheric pressure is provided in the cavity 4. Furthermore, the housing 3 of the oven 20 preferably comprises an opening 11 and a door 21 capable of closing the opening 11. In a closed configuration, such a door 21 preferably constitutes at least part of a side wall of the housing. Further, the housing is preferably sealed in the closed configuration such that a sub-atmospheric pressure may be maintained inside the cavity.

The oven is provided such that a pressure of at least 200 mbar below atmospheric pressure may be maintained in the cavity. The oven may also be adapted for maintaining a pressure of 500 mbar below atmospheric pressure, but it may also be adapted for even lower pressures, such as 800 mbar below atmospheric pressure or even 950 mbar below atmospheric pressure. The vacuum oven 20 further comprises a steam generator 5 for providing steam. The steam generator 5 comprises a water inlet and a boiler. The steam generator 5, which in the present embodiment is arranged outside the cavity 4, is connected to a steam inlet 5b in the housing, such that the generated steam may be provided into the cavity.

The vacuum oven further comprises heating elements 6 arranged in the cavity 4. The purpose of the heating elements 6 is thus not to generate steam, but to provide heat for a cooking step, such as heating/re-heating step of the method of the present invention. To facilitate the heat transfer during such a cooking step, the vacuum oven 20 further comprises a fan arrangement 7 for circulating gas in the cavity. The fan arrangement 7 may significantly shorten the cooking time. An alternative or complementary way of facilitating heat transfer and thereby shorten the cooking time is to increase the humidity of the air inside the cavity 4 during cooking.

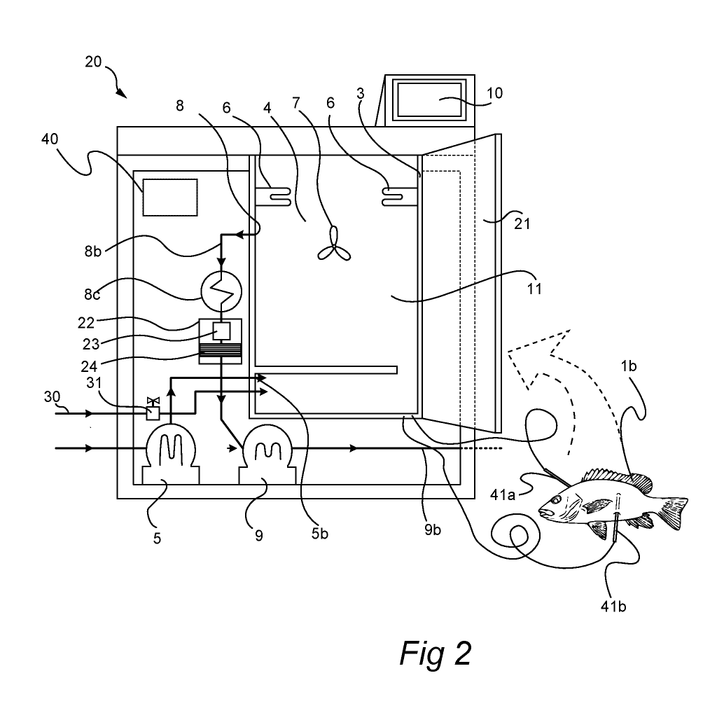

Further, the oven 20 can be provided with a controller (40 in FIG. 2) configured to control the oven 20 and its operating mode, e.g. pressure, steam cooking, temperature, timers, etc.

To provide the sub-atmospheric pressure in the cavity 4, such as in the step of setting the oven in a sub-atmospheric mode of the method of the present invention, the housing is provided with a gas outlet 8. Further, the vacuum oven 20 comprises a vacuum pump 9 connected to the gas outlet 8 via a vacuum line 8b. A heat exchanger 8 may be arranged on the vacuum line 8b. The other end of the vacuum pump 9 is connected to a drain (not shown) via an outlet line 9b.

A gas cleaning arrangement 22 is also connected to the gas outlet in order to prevent contamination of equipment arranged downstream of the gas outlet. The gas cleaning arrangement comprises a condenser 23 for condensing fatty acids, aromatic compounds and/or water vapor in the withdrawn gas. The gas cleaning arrangement also comprises a filter 24 that may be removable and cleanable.

The oven 20 also comprises an air inlet 30 comprising a valve 31, by means of which air can be let into the cavity 4 to increase the pressure to atmospheric pressure. The valve 31 can for example be a control valve that is actuated by the controller of the oven 20.

The oven 20 generally has a specified weight capacity, often indicated by an interval defining a maximum weight (M_{MAX}) of food product that the oven 20 is intended to handle. In order to be able to provide an oven with a chassis 3 containing sufficient amounts of latent heat so that the food product contained in the cavity 4 of the oven 20 keeps receiving heat through radiation, also during operation in a sub-atmospheric mode, the chassis 3 is arranged to have a total heat capacity in the range of 1.5-3.0 times that of a heat capacity of water having the same weight as said maximum weight capacity (M_{MAX}) of the oven 20. This enables the adding of heat to the food product in a sub-atmospheric pressure in a simple and energy efficient manner.

For example, a 6 GN (Gastronorm) oven with a capacity of roughly 15-24 kg of food product and having a chassis made of stainless steel, the weight of the chassis should be in the range of 300-600 kg, preferably 350-500 kg, and most preferably around 400 kg. This is because the specific heat capacity of stainless steel is 0.5 kJ/kgK as compared to the specific heat capacity of water which is ca. 4.18 kJ/kgK. In accordance with the inventive principle, this means that roughly 400 kg of stainless steel contains an equal amount of energy at the same temperature as 48 kg of water (twice the maximum weight capacity of a 6 GN oven). Thus, once the oven is heated to 100-200° C. and the food product is below these temperatures, heat radiation of at least twice the amount of energy is available in the sub-atmospheric mode of the oven 20 (i.e. 400 kg of stainless steel corresponds to 48 kg of water heating 15-24 kg of food).

Test have shown that the temperature of the chassis 3 only slowly decreases (dropping 40° C. in ca. 4 minutes at the most, if operated at 180° C. for example) in this configuration. That means that heat is added to the food which consequently increases the evaporation/dehydration speed. This in combination with cycling atmospheric and sub-atmospheric pressures results in a fast cooking (less than 20 minutes for fish), with a low final maximum temperature (60° C. for fish) and a high vapor loss (13-16%). Thus, the cooked fish has hardly any free running water and the texture is firm and flavours are concentrated at low temperature (since evaporation prevents the temperature to rise as long as free water is available, i.e. through flash cooling).

The vacuum oven 20 further comprises an interface 10, such as a screen, e.g. a touch screen, providing information about the operation of vacuum oven 20. The interface 10 may also allow the user to program the operation in the steam oven 20. For example, the user may set a temperature profile and/or a pressure profile for the operation, such that the variation of temperature, humidity and pressure in the cavity 4 over time can be set. Such (a) profile(s) may depend on the type and the thickness of the food product. The controller may therefore be connected to a valve provided in connection with the gas outlet, the fan arrangement, the at least one heating element, the steam generation arrangement and the valve of the air inlet. Via the connections, the controller may submit control signals. The controller can be provided by means of appropriate software, hardware or a combination thereof.

The dimensions of the oven 20 are preferably about the same as the dimensions of the steam ovens in today's restaurant and food-service environments. Such steam ovens has several levels and each level is adapted to receive one so called 1/1 gastro package, two so called 1/2 gastro packages), four so called 1/4 gastro packages) or eight so called 1/8 gastro packages).

The height of the cavity may be at least 200 mm, such as at least 500 mm, such as at least 1300 or 1800 mm. This means that the oven 20 may have several levels such that several 1/1 gastro packages can be placed in the oven.

The oven 20 is preferably operable in at least three different modes including:

(a) dry heating (at atmospheric pressure);

(b) moist heating at atmospheric pressure; and

(c) operation at sub-atmospheric pressure.

The oven is also preferably operable in a further mode being a mix between (a) and (b) as per the inventive concept utilizing latent heat in the chassis.

The inventive oven allows for flash cooling of the food product after it is cooked in order to precisely control the core temperature of the food product by ensuring that the surrounding regions having a higher temperature doesn't increase the core temperature. By setting the pressure in the oven during the sub-atmospheric mode to a predefined value, which corresponds to a specific boiling point, the otherwise unwanted further increase of the core temperature due to temperature equalization is effectively halted. For example, the food product may be a large piece of meat, and a desired core temperature may be 72° C. and after the desired core temperature is detected, then, by setting the oven in the sub-atmospheric mode, whereby the pressure in the cavity is lowered to approximately 345 mbar, the boiling point is brought down to roughly 72° C. which results in that the portions of the meat closer to the surface (generally having a higher temperature) is flash cooled which ensures that the core temperature doesn't increase any further than 72° C. Conventionally one had to estimate how much the temperature would rise in the core after cooking due to temperature equalization. Thus the present invention greatly simplifies the cooking of e.g. meat, fish, poultry, etc. by providing a very simple and efficient means of precisely controlling the temperature of the food product without any need for estimations or guessing of a final core temperature. As an alternative, the trigger to set the oven in the sub-atmospheric mode may be based on a temperature threshold of another one of the temperature probes, which may e.g. be arranged to measure a surface temperature or peripheral temperature of the food product.

Another example would be the baking of bread, where a temperature of 100° C. is generally enough to achieve the desired effect on the starch granules, however, a problem with conventional ovens is that this is achieved after approximately half the cooking/baking time in the oven, and for the remainder of the time the outer portions of the bread are simply drying out. However, by being able to reduce the pressure in the cavity during baking and simultaneously apply heat to the bread, one can bake with a lower boiling point and conserve heat sensitive aromas and also reduce the formation of acrylamide and other unhealthy substances which form at high temperatures, resulting in a tastier and healthier end product.

The method of cooking the food comprises:

a first step in which the food product is heated in the oven 20 at approximately atmospheric pressure for a first time period, or at least a part of the first time period; and after the first period, a second step in which the food product is subjected to a sub-atmospheric pressure such that gas/air leaves the cavity 4.

The oven 20 is suitable to use for carrying out the method of cooking the food. When the food product has been placed in the oven 20, the heater 6 and fan 7 are activated and the food in the sealed package is heated for a period in the range of 10-200 min. The temperature in the oven during this first time period may be at least 70° C. or, in some embodiment, at least 80° C. The heating during the first period may be either dry heating, moist heating or a combination thereof. Consequently, during this time period, the steam generator 5 may be operated to provide steam during at least a part of the first period. After the first time period, the pressure in the oven 20 may be lowered and the food product may be subjected to a sub-atmospheric pressure in the oven 20.

The sub-atmospheric pressure is preferably at least 100 millibar (mbar) below atmospheric pressure, such as at least 200, 300, 400 or 500 mbar below atmospheric pressure. In order to comply with some regulations and legislations, the pressure may in certain situations never be below 500 mbar.

The ambient pressure of a food package 1 may be decreased gradually when the gas outlet 8 is coupled directly to a running vacuum pump 9. In that case, the pressure may decrease continuously from atmospheric pressure to a target sub-atmospheric pressure, such as 500 mbar below atmospheric pressure. A benefit of a slower decrease of the pressure is that vigorous boiling in the package may be prevented. A problem of vigorous boiling is that when the package is provided with a valve 2 it may be contaminated and loses its function. Accordingly, in one embodiment of the inventive method, the rate of pressure reduction after the first period never exceeds 500 mbar/min. When the sub-atmospheric pressure has been provided in the oven 20, the temperature in the oven when the sub-atmospheric pressure is reached may for example be 40-130° C.

In the case of a sealed package 1 with a one way valve 2, and when it is subjected to the sub-atmospheric pressure, the valve opens and the food in the package is flash cooled, which means that the need for subsequent cooling is reduced or eliminated. Further, the flash cooling may prevent over cooking. When the package has been subjected to the sub-atmospheric pressure, the pressure inside the package is so low that the need for subsequent vacuum suction is reduced or eliminated. The “vacuum” inside the packages from the inventive method helps preserving the cooked food.

During the method, the gas phase temperature in the sealed package should never exceed 80° C. This is achievable by controlling the temperature in the oven and the subsequent sub-atmospheric pressure. When fish is cooked, a final temperature of the fish meat of about 55-70° C., such as 60-70° C., may be desired. If the temperature of the fish meat exceeds 70° C., it may be overcooked, while the fish meat may be under-cooked if it never reaches 55 or 60° C. For beef or lamb, a final temperature of the meat of about 60-70° C., may be desired. When poultry is cooked, a final temperature of the meat of about 72-82° C. may be desired. If the temperature of the poultry exceeds 82° C., it may be overcooked, while a temperature of at least 72° C. is often required to ensure that listeria and salmonella bacteria are killed. Similar temperatures are desired for pork. To obtain flash cooling at 82° C., a pressure of about 50 kPa (about 500 mbar below atmospheric pressure) is needed.

To obtain flash cooling at 70° C., a pressure of about 30 kPa (about 700 mbar below atmospheric pressure) is needed. To obtain flash cooling already at 60° C., a pressure of about 20 kPa (about 800 mbar below atmospheric pressure) is needed. Other types of food, such as lasagna, meatballs, stews, rise-based meals and vegetables can reach a higher temperature, such as 80-90° C., without being overcooked. Sometimes, such temperatures are even required to meet food safety regulations. Accordingly, a sub-atmospheric temperature of 250-600 mbar below atmospheric pressure, such as 250-500 mbar below atmospheric pressure, may be sufficient for such types of food.

FIG. 2 is a schematic illustration of an oven in accordance with another embodiment of the invention. This embodiment serves to elucidate the versatile and autonomous capabilities of an oven according to the invention. The operation of the oven in FIG. 2 is largely analogous to the oven the described in reference to FIG. 1, thus for the sake of brevity, similar functions and structures will not be discussed in further detail.

However, the oven 20 illustrated in FIG. 2 comprises two temperature probes 41a-b, being arranged to measure temperatures at two different regions in a food product 1b (here in the form of a fish). The figure also shows a controller 40 of the oven, the oven is preferably in operable connection with all operational components of the oven 20, such as e.g. the heating elements 6, the steam generator 5, the fan arrangement 7, vacuum pump 9, heat exchanger 8c, air inlet valve 31, temperature probes 41, (graphical) interface 10, etc. In this particular arrangement, there is one temperature probe 41a is arranged to measure the core temperature of the fish 1b and the other temperature probe 41b is arranged just below the skin to measure the surface temperature of the fish, i.e. a core temperature probe 41a and a surface temperature probe 41b.

The controller 40 is then provided with a surface maximum threshold of e.g. 75° C. for the surface temperature probe 41b. The fish 1b is then placed in the oven which is set to operate at an oven temperature in the range of e.g. 150-240° C., and when a surface temperature of 75° C. is detected by the surface temperature probe, the controller 40 sets the oven in a sub-atmospheric mode by e.g. controlling the vacuum pump 9. Hereby, the fish 1b is flash cooled down to a temperature dictated by the set pressure inside the cavity 11 which corresponds to a boiling point. Preferably the controller sets the pressure in the sub-atmospheric mode to correspond to a boiling point in the range of 32° C. to 70° C. The oven is kept in the sub-atmospheric pressure mode for a predefined period of time (e.g. a few minutes) or until the surface temperature probe detects a lower predefined threshold. Next, the controller increases the pressure inside the cavity again to an atmospheric pressure level (by e.g. controlling the air inlet valve 31) and turns on the heating elements 6 (and optionally the steam generating arrangement 5) in order to proceed with the cooking of the fish 1b. The fish 1b is then heated until the surface temperature probe detects a temperature of 75° C. again, whereby the controller 40 sets the oven 20 in the sub-atmospheric mode again. The controller 40 then repeats these pressure cycles until the core temperature probe reaches a predefined final core temperature value, e.g. somewhere in the range of 55-65° C. Optionally, a final flash cooling step may be included after the final core temperature is reached in order to reduce any heat equalization within the fish, which may cause an undesirable increase of the core temperature. This arrangement and configuration drastically improves the precision of cooking delicate food products and ensures even cooking of the same in a simple and efficient manner. Moreover, very advanced cooking processes are simplified and it allows regular persons (non-professionals) to achieve great results in the kitchen.

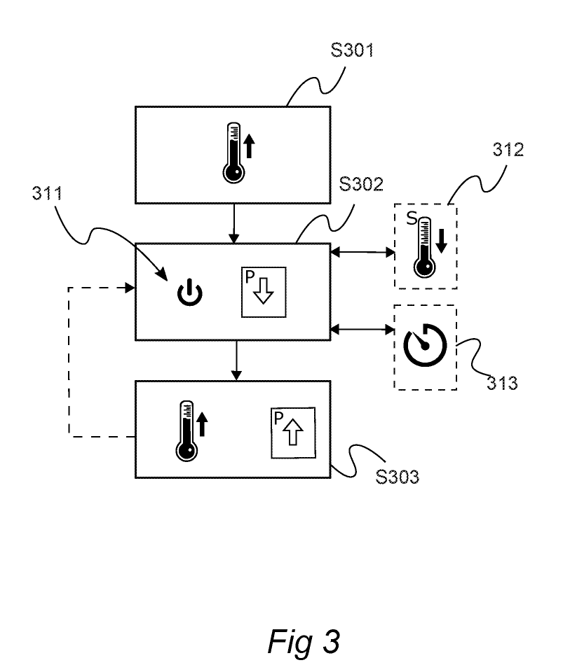

FIG. 3 shows a flow chart representing a method in accordance with an embodiment of the present invention. The method can be a method of cooking food in an oven 20 as described in reference to FIG. 1.

The method includes a first step of heating S301 the food or food product inside the cavity of the oven at an atmospheric pressure, i.e. in a rather conventional manner. However, this first heating step S301 may be performed in accordance with a predefined delta-T, meaning that a controller in the oven is configured to measure e.g. a core temperature of the food product in the oven and keep a dynamic temperature difference according to the predefined delta-T in the oven, e.g. in the range of 20 to 50° C. The food product is heated S301 until a predefined core temperature is reached, which can be measured by an appropriately arranged temperature probe (41 in FIG. 2).

Once the actual core temperature reaches the predefined core temperature the pressure inside the cavity is decreased S302 to a sub-atmospheric pressure level, as indicated in the box S302. Furthermore, the heating element(s) and any steam generating arrangement in the oven are turned off 311. Also, if there is any fan arrangement it is preferably turned off and sealed while the pressure inside the cavity is below an atmospheric pressure level. The sub-atmospheric pressure is preferably maintained for a predefined period of time 313 or until a predefined surface temperature 312 of the food product is reached due to flash cooling. For example, the pressure inside the cavity may be decreased to approx. 160 mbar which corresponds to a boiling point of approx 50° C., thus after a short period of time the surface temperature will be reduced to 50° C. (assuming that the surface temperature was higher prior to the decrease S302 in pressure). In other words, if the core temperature was 50° C. prior to the decreasing step S302 and the surface temperature was higher (e.g. closer to 70° C.), then after the completion of the decreasing step S302 the surface temperature will be reduced and the temperature profile in the food product will be of a more uniform character, reducing the risk of overcooking any portion of the food product.

Next, when the goal surface temperature 312 is reached or after the predefined period of time 313 has passed, the pressure inside the cavity is once again increased S303 to an atmospheric pressure level and maintained until e.g. the core temperature reaches a second predefined core temperature. Any heating element(s), steam generating arrangements or fan arrangements that were turned off 311 previously can be tuned on again. The steps S302, S303 may then accordingly be repeated as indicated by the broken arrow depending on application. After any sub-atmospheric step S302 the temperature profile of the food product is made more uniform, thus when a subsequent heating step S303 at atmospheric pressure commences the surface portions of the food product are effectively kept from overcooking.

The method facilitates cooking in terms of that an even temperature distribution throughout the whole food product and during the whole cooking process is achieved. Moreover, the chassis ensures that a minimum amount of energy is lost during the pressure cycles, which increases the overall energy efficiency of the cooking process. The later heating (or re-heating) steps S303 may also advantageously be performed by operating the oven according to a predefined subsequent delta-T that is lower than the preceding delta-T defined in a previous heating step, (i.e. a double delta-T or triple delta-T method, depending on how many cycles are executed) which also increases the even temperature distribution in the food product.

1. A method of cooking a food product in an oven operable for cooking at both atmospheric and sub-atmospheric pressure, the oven comprising a cavity containing a food product, said method comprising:
(i) at atmospheric pressure, heating said food product inside said cavity, until a predefined core temperature threshold is reached at a core region of said food product or until a predefined maximum surface temperature threshold is reached at a surface region of said food product;
(ii) decreasing the pressure inside said cavity to a sub-atmospheric pressure level and maintaining said sub-atmospheric pressure level for a predefined period of time or until a surface region of said food product reaches a predefined flash cooling temperature threshold;
(iii) increasing the pressure inside said cavity to atmospheric pressure and, if said core temperature threshold has not been reached, re-heating said food product inside said cavity until the predefined core temperature threshold is reached in said core region or until said predefined maximum surface temperature threshold is reached again at the surface region of said food product.

2. The method according to claim 1, wherein said step of decreasing the pressure comprises turning off any heating element in said oven.

3. The method according to claim 1, wherein said steps of decreasing the pressure and increasing the pressure and re-heating are performed at least two times.

4. The method according to claim 1, wherein said heating is performed at a first oven temperature defining a first delta-T, and wherein each subsequent re-heating is performed at a second oven temperature defining a subsequent delta-T being smaller than any preceding delta-T.

5. The method according to claim 1, further comprising:
(iv) repeating steps (ii) and (iii), until the predefined core temperature threshold is reached in the core region of said food product.

6. The method according to claim 1, further comprising:
(iv) repeating steps (ii) and (iii), until a predefined moisture content of said food product is reached.

7. An oven operable for cooking at both atmospheric and sub-atmospheric pressure, said oven comprising:
a housing defining a chassis comprising a cavity capable of receiving a food package including a food product;
at least one heating element;
a gas outlet connectable to a vacuum source for withdrawing gas from said cavity in order to set said oven in a sub-atmospheric mode;
a controller configured to control said oven and to cycle different pressure and temperature profiles based on a predefined user-setting;
a temperature probe connected to said controller and arranged to measure a temperature of said food product; and
wherein said controller is further configured to:
receive and store a temperature threshold for the temperature probe;
control said heating element in order to heat said food product arranged in said cavity at said oven temperature;
set said oven in the sub-atmospheric mode when said temperature probe detects the temperature threshold.

8. The oven according to claim 7, wherein said temperature probe is a core temperature probe arranged to measure a core temperature of said food product and said temperature threshold is a first temperature threshold, and wherein said controller is further configured to:
receive and store a second temperature threshold for said core temperature probe, said second temperature threshold being higher than said first temperature threshold;
control said heating element in order to heat said food product arranged in said cavity at a predefined oven temperature;
set said oven in the sub-atmospheric mode by controlling said vacuum source, when said first temperature threshold is detected by said core temperature probe in order to cool the food product;
increase the pressure in said cavity by introducing air to the cavity and control said heating element in order to heat the food product again until said second temperature threshold is detected by said core temperature probe.

9. The oven according to claim 7, wherein said temperature probe is a core temperature probe arranged to measure a core temperature of said food product and said temperature threshold is a core temperature threshold, and wherein said oven further comprises:
a surface temperature probe connected to the controller, said surface temperature probe being arranged to measure a temperature of a surface region of the food product; and
wherein the controller is further configured to:
(i) receive and store a predefined maximum surface temperature threshold and a predefined flash-cooling temperature threshold for the surface temperature probe,
(ii) at atmospheric pressure, control the heating element in order to heat the food product inside said cavity, until the core temperature threshold is detected by the core temperature probe or until the predefined maximum surface temperature threshold is detected by the surface temperature probe,
(iii) set the oven in the sub-atmospheric mode for a predefined duration of time or until the predefined flash cooling temperature threshold is detected the surface temperature probe, by controlling the vacuum source, and
(iv) if the maximum surface temperature threshold was detected first, repeat steps (ii) and (iii), until the predefined core temperature threshold is reached in a core region of the food product.

10. The oven according to claim 7, wherein said oven has a maximum weight capacity for said food product and wherein said chassis is arranged to have a total heat capacity in the range of 1.5-3.0 times that of a heat capacity of water having the same weight as said maximum weight capacity of said oven.

11. The oven according to claim 10, wherein said chassis comprises stainless steel.

12. The oven according to claim 10, wherein a weight of said chassis is 300-500 kg.

13. The oven according to claim 7, wherein said controller is further configured to turn off said heating element during the time the oven is in the sub-atmospheric mode.

14. The oven according to claim 7, further comprising a steam-generating arrangement for providing steam in said cavity.

15. The oven according to claim 14, wherein during said sub-atmospheric pressure mode, said controlled is further configured to turn off said steam generating arrangement.
